(19) United States
(12) Patent Application Publication
(10) Pub. No.: US 2006/0130156 A1
(43) Pub. Date: Jun. 15, 2006

(54) Digital self-erasure of key copy-protected storage

(75) Inventors: Sheau Bao Ng, Wayland, MA (US); Richard Chi-Te Shen, Morgan Hill, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/560,721

(22) PCT Filed: Jun. 29, 2004
(86) PCT No.: PCT/IB04/51049

§ 371 Date: Dec. 15, 2005

(30) Foreign Application Priority Data
Jun. 30, 2003 (US) 60/483778

(51) Int. Cl. G06F 17/30

(52) U.S. Cl. 726/33

(57) ABSTRACT

First and second portions of memory are provided in a storage module (e.g. hard drive or flash card). The first portion is for storing content (e.g. music, videos, pictures) and the second portion is for storing information (e.g. keywords or tables of content) required to access the content. When, unauthorized use of the storage module (disconnection from a playing device, opening the module, opening a playing device containing the module, attempting to access content when the module is disconnected from an authorized playing device) is detected then further access to the information stored on the second part is prevented. Access can be prevented, for example, by blank erasing the second portion. A power source (e.g. battery) is provided for the detecting and preventing of access, the access also being prevented if the power source fails.

The invention is related to the field of copy protection of digital content.

Digital storage modules are increasingly being used for storing digital content such as video, music and pictures. In many applications, such as MP3 (MPEG audio layer 3) players and PVRs (Personal Video Recorders), it is essential that the content be downloaded and stored in a storage module of the local device. Content providers are allowing paying subscribers to download content that is protected by copy right. The subscribers have no right to further distribute the content, but illegal copying has become so epidemic that it is discouraging providers from providing content for subscriber download.

Content providers are looking for ways to prevent pirates from illegally distributing the downloaded content. Previously proposals to prevent illegal copying of downloaded content have not been satisfactory. Most proposals have depended on encryption of the downloaded material, but even technically unsophisticated copiers have been able to circumvent such protections. For example, A hard disc drive module used in a PVR can be removed and the encrypted contents duplicated.

In the invention herein, a storage module is provided with multiple portions of memory including a first portion and a second portion. Content is stored in the first portion and information is stored in the second portion that is required in order to access the content stored in the first portion. When unauthorized use of the storage module is detected then the second portion is blank erased so the content can not be used.

Blank erasing data is destroying data by, for example, overwriting the data with blanks, so that the data can not be recovered. Normally when data in a storage module is erased the data itself is not modified, but a flag is marked to indicate that the location of the data is free for writing data into. One of the advantages of only blank erasing the second portion and not the first portion is that normal memory management can be used for the first portion and the special blank erasing procedure only has to be available for the second portion. Another advantage is that blank erasing may take much longer than marking that the memory position is available.

For example, the unauthorized use may be removal of the storage module from the device containing the storage module such as a VCR or MP3 player; the unauthorized use may be breaking open of the device or the module; the unauthorized use may be an attempt to read data from the module while the module is disconnected from the device.

Additional aspects and advantages of the invention will become readily apparent to those skilled in the art from the detailed description below with reference to the following drawings.

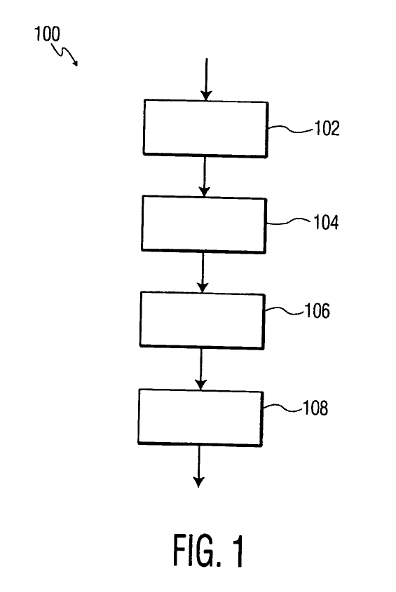

FIG. 1 is a flow diagram of the method of the invention.

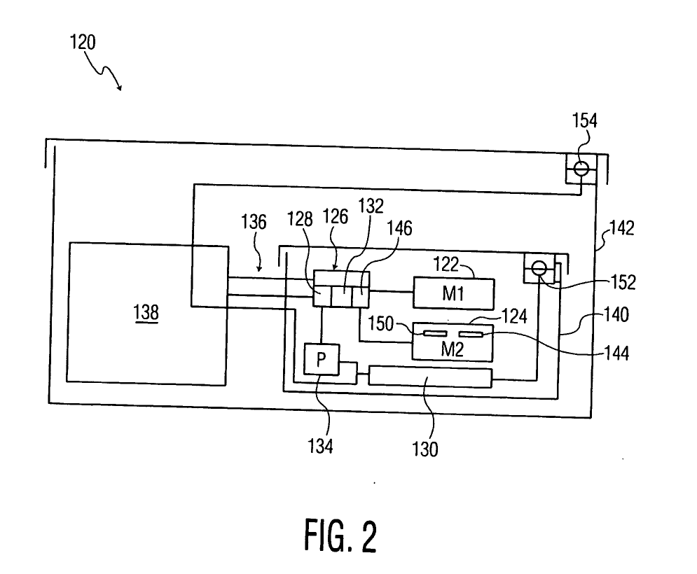

FIG. 2 is a schematic of the system of the invention including a playing device and the connected module.

FIG. 1 illustrates a flow chart of an example of the method of the invention. In step 102, multiple portions of memory are provided in a storage module. The portions of memory include a first portion for containing content and a second portion containing information that must be accessed in order to access the content stored in the first portion. In step 104, unauthorized use of the storage module is detected. The detection can include detecting: disconnection of the module from a portion of a device to which the module is connected, opening of the module, opening of the device, or attempting to access the information stored in the module while the module is not connected to an authorized device.

The digital storage module may be, for example, a hard disc drive module or a non-volatile memory module, such as a flash card.

In step 106, access to the information in the second portion after the unauthorized use is detected is prevented. Access can be prevented for example by blank erasing a private key stored in the second section that is required for decrypting the content stored in the first section. Access could also be prevented by blank erasing a table of contents of the first portion of memory that is stored in the second portion of memory.

In step 108 a power source is provided for the detecting and preventing of access, the access also being prevented if the power source fails. Commonly a battery would be used for such a power source, and the battery could be interconnected such that when the battery died then access would be prevented.

FIG. 2 is a schematic of the system of the invention including a playing device and the connected storage module. The storage module contains multiple portions of memory including a first portion (122) and a second portion (124). The storage module also contains a processors 126 containing programming modules to operate the module. The programming modules include an access control module 128 for preventing access to content stored in the first portion of memory without accessing information stored if the second portion of memory. The module contains detecting apparatus 130 for detecting unauthorized use of the storage module.

The processor also contains a protection module 132 for preventing further access of the information stored in the first portion of the memory after unauthorized use is detected. The protection module may simply blank erase the contents of the second module whenever unauthorized use is detected. A power source 134 is provided in the module for operating the detecting apparatus and processor containing the protecting module. The protecting module preventing further access to the information stored in the first portion of the memory after the power source fails.

The unauthorized use of the storage module may include unauthorized disconnection of the storage module from a device that uses the storage module. In that case, the protecting apparatus 130 monitors the continuity of the connection 136 between the module and a portion 138 of the playing device. Whenever disconnection is detected then the protecting module 132 blank erases the second portion of the memory.

The unauthorized use of the storage module may include unauthorized opening of an enclosure 140 of the storage module. In that case, the protecting apparatus 130 monitors the integrity of the module enclosure. For example, an opening detector 152 can be connected between portions of the module enclosure and if the portions of the module enclosure are separated then opening will be detected. Whenever unauthorized opening of the module enclosure is detected then the protecting module 132 blank erases the second portion of the memory.

The unauthorized use of the storage module may include unauthorized opening of an enclosure 142 of the playing device. In that case, the protecting apparatus 130 monitors the integrity of the playing device enclosure. For example, an opening detector 154 can be connected between portions of the device enclosure and if the portions of the device enclosure are separated then opening will be detected. Whenever unauthorized opening of the device enclosure is detected then the protecting module 132 blank erases the second portion of the memory.

The information stored in the second portion that has to be accessed in order to access the contents may include a private key 144 that must be used to decrypt the content stored in the first portion of the memory in order to access the content. The storage module may contain a data decryption module 146 of processor 126 for using the private key stored in the second portion of the memory for decrypting data that is stored in the first portion of the memory. Alternately or in addition to the private key, the information stored in the second portion of the memory may include a table of contents that is necessary to play the content stored in the first portion of the memory.

The invention has been described above in relation to specific example embodiments. Those skilled in the art will know how to modify these example embodiments within the scope of the invention herein. The invention is only limited by the following claims.

1. A method, comprising:
providing multiple portions of memory in a storage module, the portions including a first portion for containing content and a second portion containing information that must be accessed in order to access content stored in the first portion;
detecting unauthorized use of the storage module;
preventing access to the information in the second portion after the unauthorized use is detected;
providing a power source for the detecting and preventing of access, access also being prevented if the power source fails.

2. The method of claim 1, wherein access to the information in the second portion is prevented by blank erasing the information in the second portion when unauthorized access is detected.

3. The method of claim 1, wherein detecting of unauthorized use includes detecting unauthorized disconnection of the storage module from a device that uses the storage module.

4. The method of claim 1, wherein detecting unauthorized use includes detecting unauthorized opening of an enclosure of the storage module.

5. The method of claim 1, wherein detecting unauthorized use includes detecting unauthorized opening of an enclosure of a device containing the storage module.

6. A storage module, comprising:
multiple portions of memory including a first portion (122) and a second portion (124) of the memory;
access control means (128) for preventing access to content stored in the first portion of memory without accessing information stored if the second portion of memory;
means (130) for detecting unauthorized use of the storage module; and
protection means (132) for preventing further access to the information stored in the second portion of the memory after unauthorized use is detected; and
a power source (134) for operating the detecting means and protection means, the protection means also preventing further access to the information stored in the second portion of the memory after the power source fails.

7. The storage module of claim 6, wherein:
unauthorized use includes unauthorized disconnection of the storage module from a device that uses the storage module; and
the detecting means monitors a connection (136) between the storage module and the device that uses the storage module and the protecting means blank erases the information stored in the second portion of the memory when unauthorized disconnection of the storage module from the device is detected.

8. The storage module of claim 6, wherein:
unauthorized use includes unauthorized opening of an enclosure (140) of the storage module; and
the detecting means monitors the integrity of an enclosure of the storage module and the protecting means blank erases the information stored in the second portion of the memory when unauthorized opening of the enclosure of the storage module is detected.

9. The storage module of claim 6, wherein:
unauthorized use includes unauthorized opening of an enclosure (142) of a device containing the storage module; and
the detecting means monitors the integrity of an enclosure of the device and the protecting means blank erases the information stored in the second portion of the memory when unauthorized opening of the enclosure of the device is detected.

10. The storage module of claim 6, wherein:
The information stored in the second portion includes a private key (144) that can be used to decrypt content stored in the first portion of the memory;
the storage module further comprises a data decrypter (146) for decrypting data that is stored in the second portion of the memory using the private key that is stored in the first portion of the memory.

11. The storage module of claim 6, wherein the information stored in the second portion of the memory includes a table of contents that is necessary to play the content stored in the first portion of the memory.
